(19) United States
(12) Patent Application Publication
(10) Pub. No.: US 2022/0134462 A1
(43) Pub. Date: May 5, 2022

(54) SYSTEMS AND METHODS TO MITIGATE FUSION BETWEEN A WIRE ELECTRODE AND A WELDING TORCH

(71) Applicant: Illinois Tool Works Inc., Glenview, IL (US)

(72) Inventors: Shuang Liu, Appleton, WI (US); Robert R. Davidson, New London, WI (US)

(21) Appl. No.: 17/506,818

(22) Filed: Oct. 21, 2021

Related U.S. Application Data
(60) Provisional application No. 63/109,617, filed on Nov. 4, 2020.

(51) Int. Cl. B23K 9/09; B23K 9/095; B23K 9/12; B23K 9/007

(52) U.S. Cl. CPC B23K 9/092; B23K 9/0953; B23K 9/007; B23K 9/125; B23K 9/0956

(57) ABSTRACT

Systems and methods are described to address issues associated with welding with cored wires. In certain processes, a welding wire may “stick” or fuse to a contact tip. To mitigate the negative effects of a wire fusing to a contact tip, a double pulse waveform is applied. A first pulse is applied at a first current level above a threshold current level required to transfer a ball of molten welding wire in a peak phase, and a second pulse is applied in the background phase at a second current level below the threshold current level to limit and/or eliminate fusion between the wire and the contact tip. In examples, the second current level is sufficient to dislodge a spot weld between the welding wire and the welding torch yet insufficient to transfer a ball of molten welding wire.

### CROSS-REFERENCE TO RELATED APPLICATIONS

This application hereby claims priority to and the benefit of U.S. Provisional Application Ser. No. 63/109,617, entitled “Systems And Methods To Mitigate Fusion Between A Wire Electrode And A Welding Torch,” filed Nov. 4, 2020. U.S. Provisional Application Ser. No. 63/109,617 is hereby incorporated by reference in its entireties for all purposes.

### BACKGROUND

One of the first steps of a welding process is establishing an electrical arc between a welding torch and a workpiece. Some arc welding systems use wire electrodes fed to the welding torch to establish the electrical arc. Establishing and maintaining the electrical arc with the wire electrode is easier if the wire electrode is free of welding residue or unwanted contact with the welding torch during performance of the weld. For example, during some welding processes, the wire electrode may “stick” or fuse to a contact tip, creating issues during performance of the weld.

Limitations and disadvantages of conventional and traditional approaches will become apparent to one of skill in the art, through comparison of such systems with the present disclosure as set forth in the remainder of the present application with reference to the drawings.

### BRIEF SUMMARY

The present disclosure is directed to systems and methods for mitigating the negative effects of a wire fusing to a contact tip during a welding process, substantially as illustrated by and/or described in connection with at least one of the figures, and as set forth more completely in the claims.

These and other advantages, aspects and novel features of the present disclosure, as well as details of an illustrated example thereof, will be more fully understood from the following description and drawings.

### BRIEF DESCRIPTION OF THE DRAWINGS

FIG. 1 is a perspective view of an operator using an example welding system, in accordance with aspects of this disclosure.

FIG. 2 is a block diagram illustrating components of the example welding system of FIG. 1, in accordance with aspects of this disclosure.

FIGS. 3A and 3B are graphs illustrating an example welding program, in accordance with aspects of this disclosure.

FIG. 4 is a graph illustrating an example welding program, accordance with aspects of this disclosure.

FIGS. 5A and 5B are graphs illustrating a detailed view of the graph of FIG. 4, in accordance with aspects of this disclosure.

FIG. 6 is a diagrammatic illustration of an example welding process aligned with an example graphical representation of waveforms, in accordance with aspects of this disclosure.

FIGS. 7A and 7B are flowcharts illustrating example welding programs, in accordance with aspects of this disclosure.

The figures are not necessarily to scale. Where appropriate, the same or similar reference numerals are used in the figures to refer to similar or identical elements.

### DETAILED DESCRIPTION

Systems and methods for mitigating the negative effects of a wire fusing to a contact tip during a welding process are disclosed. In particular, the disclosed systems and methods address issues associated with welding with cored wires, although the principles may be applicable for a variety of wire types or welding processes where wire “sticking” issues exist (e.g., wire materials with a low melting point and high surface resistance; metal cored wires; stainless steel wires, etc.). For example, in certain processes, a welding wire may “stick” or fuse to a contact tip, creating issues with the advancing welding wire and subsequent transfer of a molten metal droplet. To mitigate the negative effects of a wire fusing to a contact tip during a welding process, the system is configured to command a pulse with a relatively low amount of current to dislodge the fused welding wire from the contact tip.

The disclosed systems and methods are configured to generate waveforms with a series of pulses to reduce the occurrence of a spot weld or fusion event between the welding wire and a welding torch (e.g., a contact tip), in particular, following a peak pulse of current forcing a ball of molten wire toward a workpiece. In some examples, the duration, severity, size, and thereby impact on the welding process, can be reduced or eliminated by adding another, relatively small pulse of current to break fused portion of the wire loose from the contact tip.

Cored wire, also referred to as metal-cored wire, employs an external sheath to encase powdered metals. The sheath makes electrical contact with a contact tip of a welding torch, through which a substantial amount of current flows from the contact tip to a workpiece to form a weld. For instance, welding currents can range from below 350 to over 550 Amps. Although the contact tip has a relatively large surface area, the point of contact with the wire is relatively small (e.g., with an area of 0.2 mm² or less). The transfer of high current and energy tends to generate a hot spot on the wire in a type of fusion event. For example, the hot spot can, and often does, freeze and/or solidify (e.g., fuse) as the melting metallic interface between a welding wire and a contact tip cools and creates a bond, creating a spot weld inside the contact tip and causing the wire to temporarily stop feeding.

The wire may eventually break free from the contact tip (e.g., in response to a force from a wire feeder to drive the wire). For instance, the feeder may be continuously feeding the wire until the push force is able to break the fusion point between the wire and the contact tip. However, by the time the spot weld breaks freeing up the wire, a large spring force has been built-up in the wire, which may cause the wire to rapidly advance from the contact tip at a wire feed rate several times greater than a commanded wire feed rate. As a result, the wire is thrust into the weld puddle causing a hard short. Further, in order to clear the hard short created at the weld puddle, additional current must be added, creating another hot spot, which further exacerbates the situation.

The disclosed systems and methods provide significant improvements in welding of cored wires, although the techniques disclosed herein may be applicable for any wire and/or welding process where spot welds or fusion events occur. By mitigation of the effects of such spot welds or fusion events (e.g., at an interface between the welding wire and an internal surface of the contact tip), a more consistent, stable and higher quality molten metal droplet transfer is achieved.

In some example systems, wire sticking to the contact tip is mitigated by slowing down the ramp rate from the peak current level to the background current level. This technique provides positive outcomes for relatively faster wire feed speeds. However, this technique may result in degraded performance at lower wire feed speed.

In some example systems, a narrow peak current pulse with a relatively steep up-and-down ramp rate provides better outcomes in terms of molten metal transfer when using relatively low wire feed speeds.

In some example systems, low amounts of energy added during low peak pulses (while welding with a low wire feed speed), and a corresponding slow transition from peak current to background current (e.g., with a long up-and-down ramp rate) would cause one or more of: too much energy being added to the weld; a reduction in the pinch current applied to the ball of molten welding wire on the end of the wire; an unnecessary high arc voltage and/or a spike in arc voltage; and/or the arc length to be too long.

At higher wire feed speeds, the amount of time needed to return to a background current level to prevent the wire from fusing with the contact tip increases. The reason being that a high amount of peak energy allows for manipulation of the waveform (e.g., ramp rates, peak or background current levels, etc.), while maintaining a good transfer of the molten ball of wire to the puddle.

At lower wire feed speeds fusion events such as spot welds are more challenging to mitigate. In order to reduce the amount of time the conditions exist to create a spot weld or fusion event between the welding wire and the contact tip, a partial second peak is provided to reheat the location of the fusion event (e.g., a spot weld of the welding wire to contact tip) and break it free, without adding energy at a level sufficient to create a second spot weld (and/or generate a ball of molten welding wire).

As a result, minimizing the effects on the welding process from spot welds and/or fusion events could be achieved. Thus, providing a relatively small amount of energy (e.g., a small partial peak) to heat the spot weld forces the fused material to dislodge, the welding wire thereby breaking free of the contact tip before much of a spring force has built up in the wire (due to the force provided from a wire feeder). By implementing these techniques, hard shorts caused by sudden spikes in wire feed speed advancing the welding wire into the puddle were avoided.

In additional or alternative examples, a harmonic or oscillator could be imposed over the waveform during the welding operation to constantly or periodically add small bursts of energy to clear any fusion point between the wire and the contact tip. The oscillation could be any suitable waveform, which may be synchronized or non-synchronized with the pulse waveform. The small bursts of energy would be provided with a current level below threshold current level required to transfer a ball of molten welding wire.

Advantageously, application of the disclosed systems and methods reduces sticking effects of cored wire and improves the core wire droplet transfer. Advantageously, application of the disclosed double pulse waveform allows for the background current to be reduced to a minimal amount (e.g., between 20-30 amperes) without extinguishing the arc. Then the peak current can be used more effectively to melt the wire and transfer the ball or droplet of molten welding wire.

In disclosed examples, a welding system, includes a welding power supply to provide power to a welding torch for establishing an electrical arc between a metal cored welding wire and a workpiece to perform a weld. Control circuitry is configured to control the power supply to output current as a waveform having a peak phase and a background phase. For example, the control circuitry commands the power supply to output a first pulse at a first current level above a threshold current level required to transfer a ball of molten welding wire in the peak phase, and commands the power supply to output a second pulse at a second current level below the threshold current level in the background phase, wherein the second current level is sufficient to dislodge a spot weld between the welding wire and the welding torch and not sufficient to transfer a ball of molten welding wire.

In some examples, the ball of molten welding wire is deposited onto a workpiece during the background phase. In examples, the second current level is greater than a background current level. In some examples, the peak phase and the background phase are applied in a cyclic pattern during performance of the weld.

In some examples, the control circuitry is further configured to command the second pulse at an approximate mid-point between two pulses output at the first current level. In examples, the control circuitry is further configured to command the second pulse between 0.3 and 2.0 ms after the first pulse.

In some examples, the welding wire is commanded to advance at a speed between 100 and 400 inches per minute. In examples, the threshold current level is between 100-300 amperes. In examples, the second current level is equal to or less than half of the first current level.

In some examples, the waveform further comprises one or more intermediate phases between the first pulse and the second pulse or between the second pulse and another pulse having the first current level. In some examples, the one or more intermediate phases comprises one or more knee phases, the control circuity further configured to control the power supply to command a current output at a level greater than the background current and below the second current level during the one or more knee phases.

In disclosed examples, a welding system, includes a welding power supply to provide power to a welding torch for establishing an electrical arc between the welding wire and a workpiece to perform a weld. Control circuitry is configured to control the power supply to output current as a waveform having a peak phase and a background phase, the waveform having a series of pulses alternating between a first pulse at a first current level during the peak phase, and a second pulse at a second current level during the background phase. The control circuitry is configured to command the power supply to output a first pulse at a first current level above a threshold current level required to transfer a ball of molten welding wire in the peak phase, command the power supply to output a background current at a background current level following the first pulse, and command the power supply to output a second pulse at a second current level greater than the background current level and below the threshold current level during the background phase, wherein the second current level is sufficient to dislodge a spot weld between the welding wire and the welding torch and not sufficient to transfer a ball of molten welding wire.

In examples, the welding wire is a solid wire. In some examples, the welding wire is aluminum, steel, or an alloy. In examples, the first pulse forces transfer of the ball of the welding wire onto the workpiece.

In some examples, the control circuitry is further configured to command the power supply to transition from the background phase to the peak phase by commanding another pulse at the first current level after the second pulse.

In some examples, one or more sensors to measure one or more welding parameters including voltage, wire feed speed, or temperature. In some examples, the control circuitry is further configured to monitor the welding parameters to determine frequency or severity of the spot weld, and adjust one of duration or current level of the second or the first pulse in response.

In examples, the welding process is current controlled.

In some examples, the further comprising a wire feeder configured to advance the welding wire to the workpiece at one or more wire feed speeds. In examples, the welding wire is commanded to advance at a speed between 100 and 500 inches per minute. In examples, the control circuitry is further configured to command the wire feeder to advance the welding wire at a constant wire feed speed during the arc phase and the background phase.

In examples, the first and second pulses are commanded with a common ramp rate. In some examples, the first and second pulses are commanded with different ramp rates. In some examples, the control circuitry is further configured to control the power supply to output the first pulse to achieve a first peak current at a first current ramp rate based on a first wire feed speed. In some examples, the control circuitry is further configured to control the power supply to output the first pulse to achieve a first peak current at a second current ramp rate based on a second wire feed speed.

In disclosed examples, a welding system includes a welding power supply to provide power to a welding torch for establishing an electrical arc between the welding wire and a workpiece to perform a weld. Control circuitry is configured to control the power supply to output a waveform having a peak phase and a background phase, the waveform having a series of pulses alternating between a first pulse at a first current level during the peak phase, and a second pulse at a second current level during the background phase. The control circuitry is configured to command the power supply to output a first pulse at a first current level above a threshold current level required to transfer a ball of molten welding wire in the peak phase, command the power supply to output a background current at a background current level following the first pulse, monitor one or more welding parameters, detect a fusion event based on the one or more welding parameters, and command the power supply to output a second pulse at a second current level greater than the background current level and below the threshold current level during the background phase in response to detection of the fusion event, wherein the second current level is sufficient to dislodge a spot weld created by the fusion event between the welding wire and the welding torch and not sufficient to transfer a ball of molten welding wire.

As used herein, the terms “first” and “second” may be used to enumerate different components or elements of the same type, and do not necessarily imply any particular order.

The term “welding-type system,” as used herein, includes any device capable of supplying power suitable for welding, plasma cutting, induction heating, Carbon Arc Cutting-Air (e.g., CAC-A), and/or hot wire welding/preheating (including laser welding and laser cladding), including inverters, converters, choppers, resonant power supplies, quasi-resonant power supplies, etc., as well as control circuitry and other ancillary circuitry associated therewith.

As used herein, the term “welding power” or “welding-type power” refers to power suitable for welding, plasma cutting, induction heating, CAC-A and/or hot wire welding/preheating (including laser welding and laser cladding). As used herein, the term “welding-type power supply” and/or “power supply” refers to any device capable of, when power is applied thereto, supplying welding, plasma cutting, induction heating, CAC-A and/or hot wire welding/preheating (including laser welding and laser cladding) power, including but not limited to inverters, converters, resonant power supplies, quasi-resonant power supplies, and the like, as well as control circuitry and other ancillary circuitry associated therewith.

As used herein, the term “torch,” “welding torch,” “welding tool” or “welding-type tool” refers to a device configured to be manipulated to perform a welding-related task, and can include a hand-held welding torch, robotic welding torch, gun, gouging tool, cutting tool, or other device used to create the welding arc.

As used herein, the term “welding mode,” “welding process,” “welding-type process” or “welding operation” refers to the type of process or output used, such as current-controlled (CC), voltage-controlled (CV), pulsed, gas metal arc welding (GMAW), flux-cored arc welding (FCAW), gas tungsten arc welding (GTAW, e.g., TIG), shielded metal arc welding (SMAW), spray, short circuit, CAC-A, gouging process, cutting process, and/or any other type of welding process.

As used herein, the term “welding program” or “weld program” includes at least a set of welding parameters for controlling a weld, which may include a weld schedule, operational settings, or others. A welding program may further include other software, algorithms, processes, or other logic to control one or more welding-type devices to perform a weld.

As used herein, “power conversion circuitry” and/or “power conversion circuits” refer to circuitry and/or electrical components that convert electrical power from one or more first forms (e.g., power output by a generator) to one or more second forms having any combination of voltage, current, frequency, and/or response characteristics. The power conversion circuitry may include safety circuitry, output selection circuitry, measurement and/or control circuitry, and/or any other circuits to provide appropriate features.

As used herein, the terms “coupled,” “coupled to,” and “coupled with,” each mean a structural and/or electrical connection, whether attached, affixed, connected, joined, fastened, linked, and/or otherwise secured. As used herein, the term “attach” means to affix, couple, connect, join, fasten, link, and/or otherwise secure. As used herein, the term “connect” means to attach, affix, couple, join, fasten, link, and/or otherwise secure.

As used herein the terms “circuits” and “circuitry” refer to any analog and/or digital components, power and/or control elements, such as a microprocessor, digital signal processor (DSP), software, and the like, discrete and/or integrated components, or portions and/or combinations thereof, including physical electronic components (i.e., hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, circuitry is “operable” and/or “configured” to perform a function whenever the circuitry comprises the necessary hardware and/or code (if any is necessary) to perform the function, regardless of whether performance of the function is disabled or enabled (e.g., by a user-configurable setting, factory trim, etc.).

The terms “control circuit,” “control circuitry,” and/or “controller,” as used herein, may include digital and/or analog circuitry, discrete and/or integrated circuitry, microprocessors, digital signal processors (DSPs), and/or other logic circuitry, and/or associated software, hardware, and/or firmware. Control circuits or control circuitry may be located on one or more circuit boards that form part or all of a controller, and are used to control a welding process, a device such as a power source or wire feeder, and/or any other type of welding-related system.

As used herein, the term “processor” means processing devices, apparatus, programs, circuits, components, systems, and subsystems, whether implemented in hardware, tangibly embodied software, or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processor may be, for example, any type of general purpose microprocessor or microcontroller, a digital signal processing (DSP) processor, an application-specific integrated circuit (ASIC), a graphic processing unit (GPU), a reduced instruction set computer (RISC) processor with an advanced RISC machine (ARM) core, etc. The processor may be coupled to, and/or integrated with a memory device.

As used, herein, the term “memory” and/or “memory device” means computer hardware or circuitry to store information for use by a processor and/or other digital device. The memory and/or memory device can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), a computer-readable medium, or the like. Memory can include, for example, a non-transitory memory, a non-transitory processor readable medium, a non-transitory computer readable medium, non-volatile memory, dynamic RAM (DRAM), volatile memory, ferroelectric RAM (FRAM), first-in-first-out (FIFO) memory, last-in-first-out (LIFO) memory, stack memory, non-volatile RAM (NVRAM), static RAM (SRAM), a cache, a buffer, a semiconductor memory, a magnetic memory, an optical memory, a flash memory, a flash card, a compact flash card, memory cards, secure digital memory cards, a microcard, a minicard, an expansion card, a smart card, a memory stick, a multimedia card, a picture card, flash storage, a subscriber identity module (SIM) card, a hard drive (HDD), a solid state drive (SSD), etc. The memory can be configured to store code, instructions, applications, software, firmware and/or data, and may be external, internal, or both with respect to the processor 130.

The term “power” is used throughout this specification for convenience, but also includes related measures such as energy, current, voltage, resistance, conductance, and enthalpy. For example, controlling “power” may involve controlling voltage, current, energy, resistance, conductance, and/or enthalpy, and/or controlling based on “power” may involve controlling based on voltage, current, energy, resistance, conductance, and/or enthalpy.

As used herein, a welding power supply, a welding-type power supply and/or power source refers to any device capable of, when power is applied thereto, supplying welding, cladding, brazing, plasma cutting, induction heating, laser (including laser welding, laser hybrid, and laser cladding), carbon arc cutting or gouging, and/or resistive preheating, including but not limited to transformer-rectifiers, inverters, converters, resonant power supplies, quasi-resonant power supplies, switch-mode power supplies, etc., as well as control circuitry and other ancillary circuitry associated therewith.

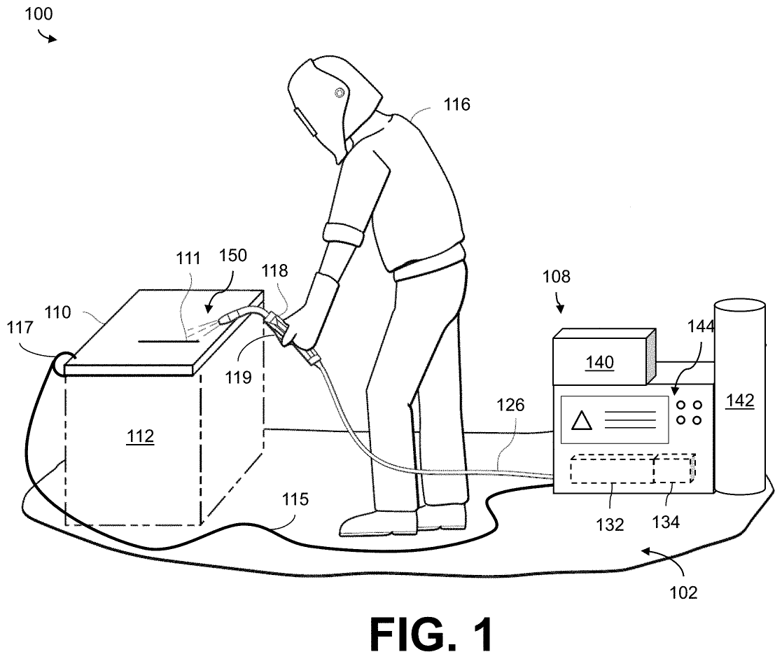

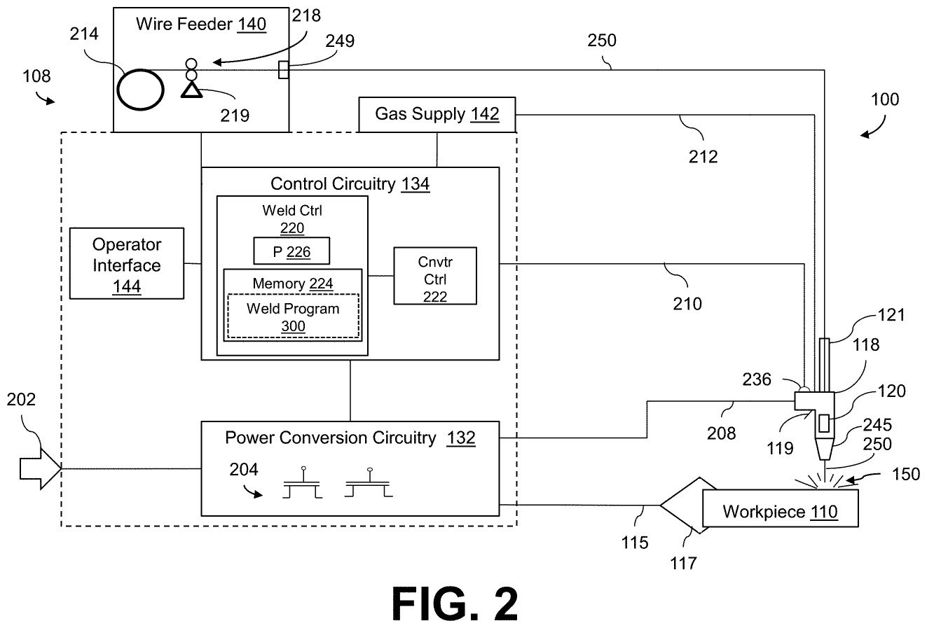

Turning now to the figures, FIGS. 1 and 2 show an example perspective and block diagram view, respectively, of a welding system 100. In the example of FIG. 1, the welding system 100 includes a welding torch 118 and work clamp 117 coupled to a welding power supply 108 within a welding cell 102. In the example of FIG. 1, the welding torch 118 is coupled to the welding power supply 108 via a welding cable 126, while the clamp 117 is coupled to the welding power supply 108 via a clamp cable 115. In the example of FIG. 1, an operator 116 is handling the welding torch 118 near a welding bench 112 that supports a workpiece 110 coupled to the work clamp 117. While only one workpiece 110 is shown in the examples of FIGS. 1 and 2, in some examples there may be several workpieces 110. While a human operator 116 is shown in FIG. 1, in some examples, the operator 116 may be a robot and/or automated welding machine.

In the example of FIG. 1, the welding torch 118 is a welding gun configured for gas metal arc welding (GMAW). In some examples, the welding torch 118 may comprise a gun configured for flux-cored arc welding (FCAW). In the examples of FIGS. 1 and 2, the welding torch 118 includes a trigger 119. In some examples, the trigger 119 may be activated by the operator 116 to trigger a welding operation (e.g., an arc welding process). In some examples, such as a robotic and/or automated welding process, a welding schedule or welding process may be accessed from a memory (e.g., memory 224 of FIG. 2) to automatically initiate one or more welds.

In the example of FIGS. 1 and 2, the welding power supply 108 includes (and/or is coupled to) a wire feeder 140. In the example of FIG. 2, the wire feeder 140 houses a wire spool 214 that is used to provide the welding torch 118 with a wire electrode 250 (e.g., solid wire, cored wire, coated wire, etc.). In the example of FIG. 2, the wire feeder 140 further includes rollers 218 configured to feed the wire electrode 250 to the torch 118 (e.g., from the spool 214) and/or retract the wire electrode 250 from the torch 118 (e.g., back to the spool 214). As shown, the wire feeder 140 further includes a motor 219 (e.g., drive mechanism or similar) configured to turn one or more of the rollers 218, so as to feed (and/or retract) the wire electrode 250. In some examples, the welding system 100 may be a push/pull system, and the welding torch 118 may also include one or more rollers 218 and/or motors 219 configured to feed and/or retract the wire electrode 250. A wire feed speed sensor 249 is configured to measure the actual speed of the wire electrode 250 as it advances from the wire feeder, and may be arranged on the wire feeder 140 or at additional or alternative locations of the welding system 100 (e.g., at the power supply 108, welding torch 118, etc.). While, in the example of FIG. 2, the wire electrode 250 is depicted as being fed from the wire feeder 140 to the welding torch 118 in isolation, in some examples the wire electrode 250 may be routed through the welding cable 126 shown in FIG. 1 with other components of the welding system 100 (e.g., gas, power, etc.). In some examples, the welding torch 118 includes a separate wire feeder unit 120 configured to advance and/or retract the wire electrode 250 independently of or in concert with wire feeder 140. Thus, reference to a wire feeder and/or wire feed system (and/or associated motors, drive rolls and/or drive mechanisms) may include one or both of the wire feeder 140 and wire feeder unit 120. In some examples, a buffer 121 may be included to allow for retraction of the wire electrode 250 (e.g., via wire feeder unit 120) at the welding torch 118 without conflicting with a force on the wire electrode 250 from the wire feeder unit 140.

In the example of FIGS. 1 and 2, the welding power supply 108 also includes (and/or is coupled to) a gas supply 142. In the example of FIG. 2, the gas supply 142 is connected to the welding torch 118 through line 212. In some examples, the gas supply 142 supplies a shielding gas and/or shielding gas mixtures to the welding torch 118 (e.g., via line 212). A shielding gas, as used herein, may refer to any gas (e.g., CO2, argon) or mixture of gases that may be provided to the arc and/or weld pool in order to provide a particular local atmosphere (e.g., shield the arc, improve arc stability, limit the formation of metal oxides, improve wetting of the metal surfaces, alter the chemistry of the weld deposit, and so forth). While depicted as its own line 212 in the example of FIG. 2, in some examples the line 212 may be incorporated into the welding cable 126 shown in FIG. 1.

In the example of FIGS. 1 and 2, the welding power supply 108 also includes an operator interface 144. In the example of FIG. 1, the operator interface 144 comprises one or more adjustable inputs (e.g., knobs, buttons, switches, keys, etc.) and/or outputs (e.g., display screens, lights, speakers, etc.) on the welding power supply 108. In some examples, the operator interface 144 may comprise a remote control and/or pendant. In some examples, the operator 116 may use the operator interface 144 to enter and/or select one or more weld parameters (e.g., voltage, current, gas type, wire feed speed, workpiece material type, filler type, etc.) and/or weld operations for the welding power supply 108. In some examples, the weld parameters and/or weld operations may be stored in a memory 224 of the welding power supply 108 and/or in some external memory. The welding power supply 108 may then control (e.g., via control circuitry 134) its operation according to the weld parameters and/or weld operations.

In some examples (e.g., where the operator is a robot and/or automated welding machine), the operator interface 144 may be used to start and/or stop a welding process (e.g., stored in memory 224 and executed via control circuitry 134). In some examples, the operator interface 144 may further include one or more receptacles configured for connection to (and/or reception of) one or more external memory devices (e.g., floppy disks, compact discs, digital video disc, flash drive, etc.). In the example of FIG. 2, the operator interface 144 is communicatively coupled to control circuitry 134 of the welding power supply 108, and may communicate with the control circuitry 134 via this coupling.

In the example of FIGS. 1 and 2, the welding power supply 108 is configured to receive input power (e.g., from AC mains power, an engine/generator, a solar generator, batteries, fuel cells, etc.), and convert the input power to DC (and/or AC) output power (e.g., welding output power). In the example of FIG. 2, the input power is indicated by arrow 202. In the example of FIG. 1, the output power may be provided to the welding torch 118 via welding cable 126. In the example of FIG. 2, the output power may be provided to the welding torch 118 via line 208. While depicted as its own line 208 in the example of FIG. 2 for ease of explanation, in some examples the line 208 may be part the welding cable 126 shown in FIG. 1. In the example of FIGS. 1 and 2, the output power may be provided to the clamp 117 (and/or workpiece(s) 110) via clamp cable 115.

In the example of FIGS. 1 and 2, the welding power supply 108 includes power conversion circuitry 132 configured to convert the input power to output power (e.g., welding output power and/or other power). In some examples, the power conversion circuitry 132 may include circuit elements (e.g., transformers, rectifiers, capacitors, inductors, diodes, transistors, switches, and so forth) capable of converting the input power to output power. In the example of FIG. 2, the power conversion circuitry 132 includes one or more controllable circuit elements 204. In some examples, the controllable circuit elements 204 may comprise circuitry configured to change states (e.g., fire, turn on/off, close/open, etc.) based on one or more control signals. In some examples, the state(s) of the controllable circuit elements 204 may impact the operation of the power conversion circuitry 132, and/or impact characteristics (e.g., current/voltage magnitude, frequency, waveform, etc.) of the output power provided by the power conversion circuitry 132. In some examples, the controllable circuit elements 204 may comprise, for example, switches, relays, transistors, etc. In examples where the controllable circuit elements 204 comprise transistors, the transistors may comprise any suitable transistors, such as, for example MOSFETs, JFETs, IGBTs, BJTs, etc.

In some examples, the controllable circuit elements 204 of the power conversion circuitry 132 may be controlled by (and/or receive control signals from) control circuitry 134 of the welding power supply 108. In the examples of FIG. 2, the welding power supply 108 includes control circuitry 134 electrically coupled to the power conversion circuitry 132. In some examples, the control circuitry 134 operates to control the power conversion circuitry 132, so as to ensure the power conversion circuitry 132 generates the appropriate welding power for carrying out the desired welding operation.

In the example of FIG. 2, the control circuitry 134 includes a weld controller 220 and a converter controller 222. As shown the weld controller 220 and converter controller 222 are electrically connected. In some examples, the converter controller 222 controls the power conversion circuitry 132 (e.g., via the controllable circuit elements 204), while the weld controller 220 controls the converter controller 222 (e.g., via one or more control signals). In some examples, the weld controller 220 may control the converter controller 222 based on weld parameters and/or weld operations input by the operator (e.g., via the operator interface 144) and/or input programmatically. For example, an operator may input one or more target weld operations and/or weld parameters through the operator interface 144, and the weld controller 220 may control the converter controller 222 based on the target weld operations and/or weld parameters. The converter controller 222 may in turn control the power conversion circuitry 132 (e.g., via the controllable circuit elements 204) to produce output power in line with the weld operations and/or weld parameters. In some examples, the converter controller 222 may only send control signals to the power conversion circuitry 132 if an enable signal is provided by the weld controller 220 (and/or if the enable signal is set to true, on, high, 1, etc.).

In the example of FIG. 2, the weld controller 220 includes memory 224 and one or more processors 226. In some examples, the one or more processors 226 may use data stored in the memory 224 to execute certain control algorithms. The data stored in the memory 224 may be received via the operator interface 144, one or more input/output ports, a network connection, and/or be preloaded prior to assembly of the control circuitry 134. In the example of FIG. 2, the memory 224 further comprises a weld program 300, further discussed below. In some examples, the weld program 300 may make use of the processors 226 and/or memory 224. Though not depicted, in some examples the converter controller 222 may also include memory and/or one or more processors.

In the example of FIG. 2, the control circuitry 134 is in electrical communication with one or more sensors 236 via line 210. While shown as a separate line for ease of explanation in the example of FIG. 2, in some examples, line 210 may be integrated into the weld cable 126 of FIG. 1. In some examples, the control circuitry 134 may use the one or more sensors 236 to monitor the current and/or voltage of the output power and/or welding arc 150. In some examples the one or more sensors 236 may be positioned on, within, along, and/or proximate to the wire feeder 140, weld cable 126, power supply 108, and/or torch 118. In some examples, the one or more sensors 236 may comprise, for example, current sensors, voltage sensors, impedance sensors, temperature sensors, acoustic sensors, trigger sensors, position sensors, angle sensors, and/or other appropriate sensors. In some examples, the control circuitry 134 may determine and/or control the power conversion circuitry 132 to produce an appropriate output power, arc length, and/or extension of wire electrode 250 based at least in part on feedback from the sensors 236.

In the example of FIG. 2, the control circuitry 134 is also in electrical communication with the wire feeder 140 and gas supply 142. In some examples, the control circuitry 134 may control the wire feeder 140 to output wire electrode 250 at a target speed and/or direction. For example, the control circuitry 134 may control the motor 219 of the wire feeder 140 to feed the wire electrode 250 to (and/or retract the wire electrode 250 from) the torch 118 at a target speed. In some examples, the control circuitry 134 may also control one or more motors and/or rollers of the wire feeder 120 within the welding torch 118 to feed and/or retract the wire electrode 250. In some examples, the welding power supply 108 may control the gas supply 142 to output a target type and/or amount gas. For example, the control circuitry 134 may control a valve in communication with the gas supply 142 to regulate the gas delivered to the welding torch 118.

In some examples, a welding process may be initiated when the operator 116 activates the trigger 119 of the welding torch 118 (and/or otherwise activates the welding torch 118). During the welding process, the welding power provided by the welding power supply 108 may be applied to the wire electrode 250 fed through the welding torch 118 in order to produce a welding arc 150 between the wire electrode 250 and the one or more workpieces 110. The arc 150 may complete a circuit formed through electrical coupling of both the welding torch 118 and workpiece 110 to the welding power supply 108. The heat of the arc 150 may melt portions of the wire electrode 250 and/or workpiece 110, thereby creating a molten weld pool. Movement of the welding torch 118 (e.g., by the operator) may move the weld pool, creating one or more welds 111.

In some examples, the welding process may be initiated automatically and executed via control circuitry 134 in accordance with instructions stored in memory 224, such as program 300.

When the welding process is finished, the operator 116 may release the trigger 119 (and/or otherwise deactivate the welding torch 118). In some examples, the control circuitry 134 (e.g., the weld controller 220) may detect that the welding process has finished. For example, the control circuitry 134 may detect a trigger release signal via sensor 236. As another example, the control circuitry 134 may receive a torch deactivation command via the operator interface 144 (e.g., where the torch 118 is maneuvered by a robot and/or automated welding machine). In some examples, the current being applied to the welding torch 118 is monitored, as a change in the amount of current may indicate the end of the weld.

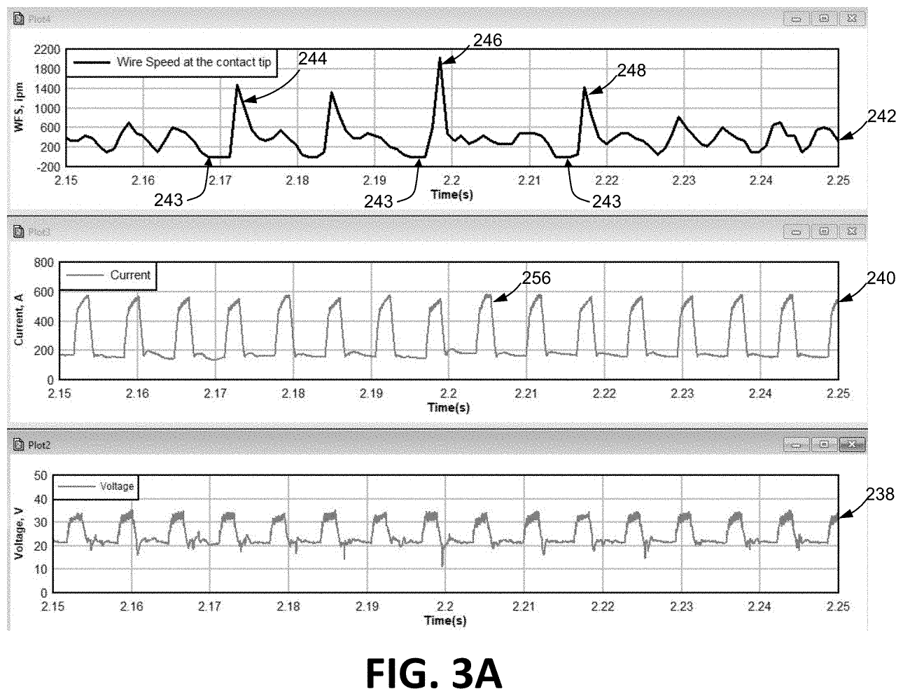

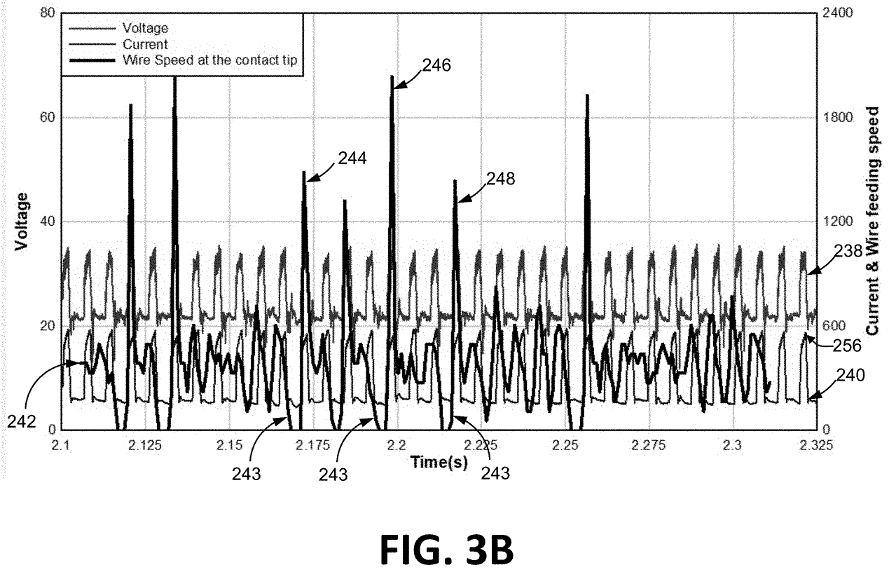

FIGS. 3A and 3B are graphs illustrating an example welding program. For instance, FIG. 3A provides three graphs, each illustrating one of a wire feed speed 242, a current waveform 240, and a voltage waveform 238 with respect to advancing time. FIG. 3B provides a single graph with each of the wire feed speed 242, the current waveform 240, and the voltage waveform 238.

In the illustrated example, the welding process is current controlled, with current output represented by waveform 240 (although in some examples the welding process may be voltage controlled, and/or controlled by one or more other welding process characteristic). Variations in voltage waveform 238 closely follows peak pulses 256. However, a graph depicting wire feed speed 242 (e.g., a measured speed of the wire as it moves through the welding torch 118 or contact tip 250) varies significantly and at random. In particular, the commanded wire feed speed is constant, yet the measured wire feed speed shown from graph 242 shows multiple peaks 244-248 with varying levels of speed. Often, these spikes follow a sharp reduction in wire feed speed 243 (to include no advancing speed at all). The reduction in wire feed speed is a result of a spot weld (e.g., fusion event), causing the welding wire to stick to the contact tip and arrest movement of the wire. Once enough force has built up behind the wire (due to the wire feeder continuing to drive the wire), the wire advances rapidly, causing the spike in wire feed speed, resulting in a hard short into the weld puddle. In some examples, the wire feed speed is commanded at about 400 inches per minute (IPM), yet the actual wire feeding speed at the contact tip can vary from about 0 IPM to about 2000 IPM. Thus, the weld is inconsistent, and the weld quality suffers.

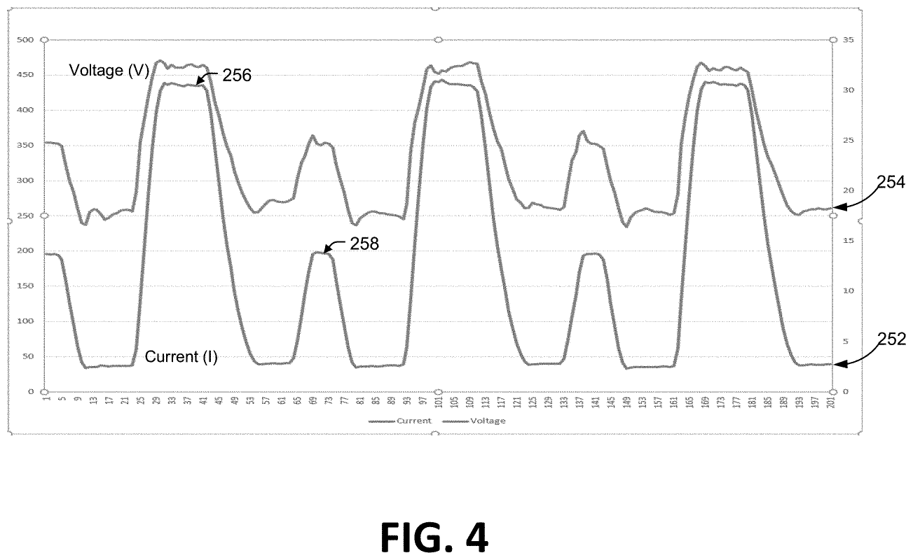

As provided in disclosed examples, an example current waveform 252 may be implemented, controlling the welding process and avoiding the issues associated with problematic fusion events. As shown in FIG. 4, current waveform 252 takes the shape of a “double pulse” waveform, with a first pulse at a first current level (e.g., a peak current level 256) and a second pulse at a second current level 258 below the first level. The first pulse is applied at or above a threshold current level sufficient to generate a ball of molten welding wire, and allow the ball to be deposited onto a workpiece. The second pulse is applied below the threshold current level sufficient to generate a ball of molten welding wire. Rather, the second current level is optimized to provide power sufficient to break a spot weld from a fusion event, but at an energy level below that required to generate a ball of molten wire.

As shown in FIG. 4, the waveform 252 is applied cyclically, with a peak current 256 being applied to successive pulses at a regular interval. As shown, the first pulse achieves the peak that is followed by a drop to a background current level. The second peak then adds a little energy to break free a spot welds in the contact tip, before too much spring force is built up (e.g., as the wire feeder continues to advance the welding wire). Further, the second pulse is applied substantially between peak current pulses. The amount of time between a peak current pulse and initiation of a second pulse allows for a cooling of the welding wire. Although illustrated as at a substantial mid-point between two peak current pulses, the timing of the second pulse is optimized to ensure proper cooling, such that the second pulse will effectively dislodge any spot weld within the contact tip. Provided the spot weld is effectively dislodged, a subsequent peak pulse may be applied more rapidly following a second peak (e.g., to initiate another transfer of welding wire material).

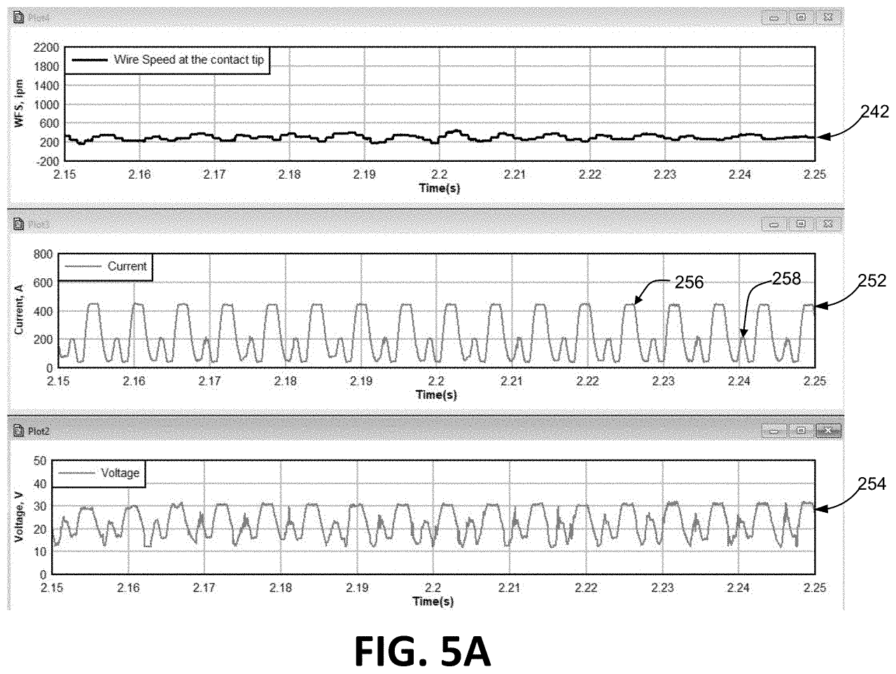

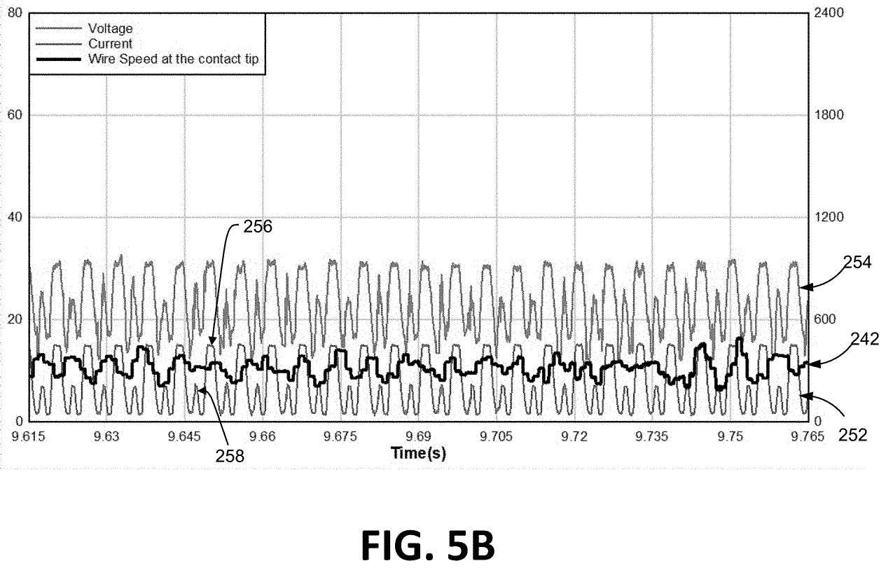

FIGS. 5A and 5B are graphs illustrating a detailed view of the graph of FIG. 4. For instance, FIG. 5A provides three graphs, each illustrating one of the wire feed speed 242, the current waveform 252, and the voltage waveform 254 with respect to advancing time. FIG. 5B provides a single graph with each of the wire feed speed 242, the current waveform 252, and the voltage waveform 254.

As shown, the double pulse current waveform 252 is applied, and as a result the wire feed speed variations are significantly reduced, as shown in the wire feed speed graphic 242. In some examples, the application of the second pulse 258 may be applied in response to a timer and/or in response to data from one or more sensors (e.g., measuring one or more welding parameter including voltage, wire feed speed, temperature, etc.).

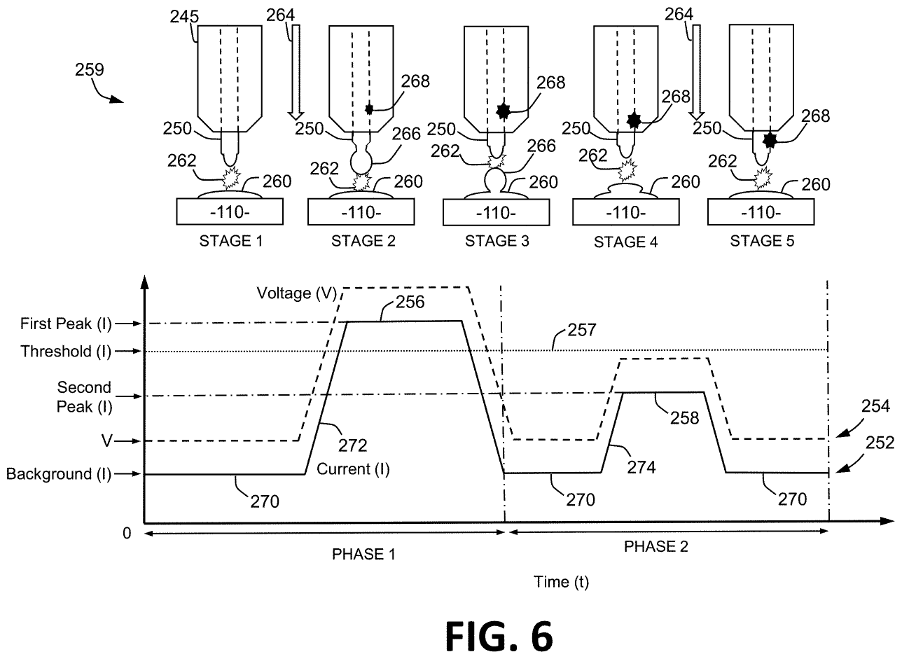

FIG. 6 is a diagrammatic illustration of an example welding process 259 performed by a contact tip 245 of welding torch 118 aligned with an example graphical representation of waveforms 252 and 254. As shown in FIG. 6, the welding wire 250 is advancing in direction 264 toward a workpiece 110 (e.g., driven by wire feeder 140 at a constant and/or variable wire feed speed). In some examples, an arc 262 may be present between the welding wire 250 and the workpiece 110 through the duration of the welding process 259. In some examples, an arc may be extinguished at one or more stages and/or timeframes during the welding process 259.

At Stage 1, the arc 262 is present at a background current level 270 during a first and/or peak phase (PHASE 1). As shown in Stage 2, the welding wire 250 continues to advance. The current supplied to the weld increases at a ramp rate 272 to a peak current level 256, causing a ball of molten welding wire 266 to form at the end of the welding wire 250. However, an unwanted spot weld 268 (fusion event) has occurred within the contact tip 245 between a portion of the welding wire and an internal surface of the contact tip 245.

At Stage 3, the ball 266 is transferred from the welding wire 250 to the weld puddle 260 as the current level drops to the background current level 270 and the welding process 259 advances to a background phase (PHASE 2). In some examples, the ball 266 is transferred at the point of transition between peak and background phases (e.g., as the current drops from peak current 256 to background current 270). In some examples, the ball 266 is transferred after the waveform has reached the background current 270 (e.g., at a relatively low current level). The spot weld 268 remains, as the current level returns to the background 270. At Stage 4, a second pulse is applied with a ramp rate 274 to achieve a commanded current level 258 sufficient to dislodge the spot weld 268, but below a current level 257 sufficient to transfer a ball of molten welding wire to the weld puddle 260. Accordingly, the spot weld 268 is dislodged and the welding wire 250 advances, without formation of another ball of molten welding wire, as shown in Stage 4. Stage 5 illustrates the advancing welding wire 250 drawing the spot weld 268 from the contact tip 268 as the welding process 259 prepares for a subsequent peak phase.

Although objects, stages, and/or phases have been illustrated relative to other objects, stages, and/or phases, the arrangements and representations are exemplary, and alternative and/or additional arrangements and representations are considered within the scope of this disclosure.

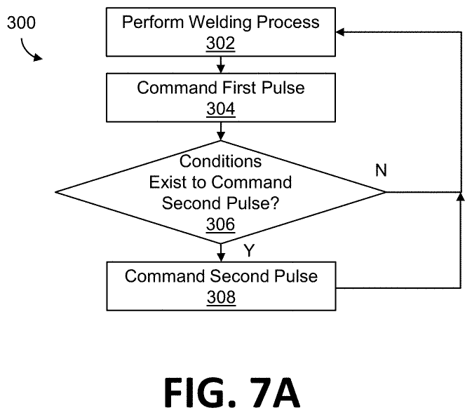

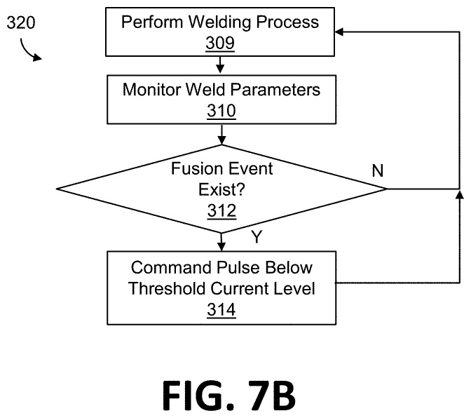

FIG. 7A is a flowchart representative of the program 300. At block 302, the program 300 performs a welding operation in accordance with a stored welding program, user input, etc. At block 304, the program 300 controls (e.g., via one or more signals) the power supply 108 to command a first pulse at a first current level above a threshold current level required to transfer a ball of molten welding wire in the peak phase.

As the ball of molten welding wire is transferred to the workpiece (e.g., in the background phase), the program 300 determines if one or more conditions exist (e.g., expiration of a timer) to command a second pulse, at block 306. If the condition does exist (e.g., expiration of the timer) the program 300 controls (e.g., via one or more signals) the power supply 108 to command a second pulse at a second current level below the threshold current level in the background phase, at block 308. The second current level is sufficient to dislodge a spot weld fusion event) between the welding wire and the welding torch and not sufficient to transfer a ball of molten welding wire (e.g., based on a timer, in response to a monitored welding parameter, etc.). For instance, this second pulse ensures that any spot weld between the wire electrode 250 and the contact tip 115 is dislodged to prevent or mitigate the opportunity for fusion.

In some examples, the second pulse the timer and/or associated timing parameters may be stored in memory 224 (e.g., as a welding process) and/or set by an operator (e.g., via the operator interface 144). The timing may be adjusted to correspond to one or more welding parameters or characteristics, such as wire feed speed, wire type, welding process, torch type, as a list of non-limiting examples.

In an additional or optional welding program 320 shown in FIG. 7B, a welding process is performed in block 309. For example, the program 320 may be performed before, after, or instead of program 300. In block 310, the program 320 monitors one or more welding parameters (e.g., of the power supply, wire feeder, and/or welding program, etc.) and/or characteristics of the wire electrode, the workpiece, and/or the welding system. At block 312, the program 309 may optionally determine whether a spot weld has occurred between the wire electrode 250 and the contact tip, or if a spot weld (e.g., a fusion event) has been avoided and/or removed.

In some examples, the program 320 may determine occurrence of a spot weld (e.g., fusion event) via detection by the control circuitry 134 (e.g., the weld controller 220). For example, a signal (and/or change in voltage and/or current) may be detected by the control circuitry 134, such as when the wire feed speed monitor 249 measures a drop in wire feed speed and/or when the motor driving the wire shows an increase in current needed to advance the welding wire.

In some examples, the program 320 may determine there is a spot weld (e.g., fusion event) based on one or more monitored parameters of the welding process (e.g., if sensor 236 detects a current outside a predetermined range of current values, a voltage outside a predetermined range of voltage values, a wire feed speed outside a predetermined range of wire feed speed values, etc.). In some examples, the program 320 may determine that there is no fusion-event (e.g., if sensor 236 detects an acceptable current, wire feed speed, and no rise in voltage). In some examples, the program may determine whether there is contact through some other means (e.g., via a camera, thermal imaging device, spectrometer, spectrophotometer, etc.).

If contact is still detected at block 312, the program 320 goes to block 314 to address the fusion by commanding another pulse of current at the second current level (e.g., current level 258) or another current level below the threshold current level. In some examples, one or more characteristics of the pulse may be adjusted based on detection or determination of contact (e.g., a spot weld, based on timing, current level, duration, etc.). If the program 320 determines that no spot weld (e.g., fusion event) has occurred or remains, the program 320 returns to block 309 to continue the welding process.

The present method and/or system may be realized in hardware, software, or a combination of hardware and software. The present methods and/or systems may be realized in a centralized fashion in at least one computing system, or in a distributed fashion where different elements are spread across several interconnected computing or cloud systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

As used herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”.

As utilized herein, the terms “e.g.,” and “for example” set off lists of one or more non-limiting examples, instances, or illustrations.

Disabling of circuitry, actuators, and/or other hardware may be done via hardware, software (including firmware), or a combination of hardware and software, and may include physical disconnection, de-energization, and/or a software control that restricts commands from being implemented to activate the circuitry, actuators, and/or other hardware. Similarly, enabling of circuitry, actuators, and/or other hardware may be done via hardware, software (including firmware), or a combination of hardware and software, using the same mechanisms used for disabling.

What is claimed is:

1. A welding system, comprising:
a welding power supply to provide power to a welding torch for establishing an electrical arc between a metal cored welding wire and a workpiece to perform a weld; and
control circuitry configured to control the power supply to output a waveform having a peak phase and a background phase, the control circuitry to:
command the power supply to output a first pulse at a first current level above a threshold current level required to transfer a ball of molten welding wire in the peak phase; and
command the power supply to output a second pulse at a second current level below the threshold current level in the background phase, wherein the second current level is sufficient to dislodge a spot weld between the welding wire and the welding torch and not sufficient to transfer a ball of molten welding wire.

2. The welding system of claim 1, wherein the ball of molten welding wire is deposited onto a workpiece during the background phase, wherein the second current level is greater than a background current level.

3. The welding system of claim 1, wherein the peak phase and the background phase are applied in a cyclic pattern during performance of the weld.

4. The welding system of claim 1, wherein the control circuitry is further configured to command the second pulse at an approximate mid-point between two pulses output at the first current level.

5. The welding system of claim 1, wherein the control circuitry is further configured to command the second pulse between 0.3 and 2.0 ms after the first pulse.

6. The welding system of claim 1, wherein the welding wire is commanded to advance at a speed between 100 and 400 inches per minute.

7. The welding system of claim 1, wherein the threshold current level is between 100-300 amperes, and wherein the second current level is equal to or less than half of the first current level.

8. The welding system of claim 1, wherein the waveform further comprises one or more intermediate phases between the first pulse and the second pulse or between the second pulse and another pulse having the first current level, wherein the one or more intermediate phases comprises one or more knee phases, the control circuity further configured to control the power supply to command a current output at a level greater than the background current and below the second current level during the one or more knee phases.

9. A welding system, comprising:
a welding power supply to provide power to a welding torch for establishing an electrical arc between the welding wire and a workpiece to perform a weld; and
control circuitry configured to control the power supply to output a waveform having a peak phase and a background phase, the waveform having a series of pulses alternating between a first pulse at a first current level during the peak phase, and a second pulse at a second current level during the background phase, wherein the control circuitry is configured to:
command the power supply to output a first pulse at a first current level above a threshold current level required to transfer a ball of molten welding wire in the peak phase;
command the power supply to output a background current at a background current level following the first pulse; and
command the power supply to output a second pulse at a second current level greater than the background current level and below the threshold current level during the background phase, wherein the second current level is sufficient to dislodge a spot weld between the welding wire and the welding torch and not sufficient to transfer a ball of molten welding wire.

10. The welding system of claim 9, wherein the welding wire is a solid wire.

11. The welding system of claim 9, wherein the welding wire is aluminum, steel, or an alloy.

12. The welding system of claim 9, wherein the first pulse forces transfer of the ball of the welding wire onto the workpiece.

13. The welding system of claim 9, wherein the control circuitry is further configured to command the power supply to transition from the background phase to the peak phase by commanding another pulse at the first current level after the second pulse.

14. The welding system of claim 9, further comprising one or more sensors to measure one or more welding parameters including voltage, wire feed speed, or temperature.

15. The welding system of claim 14, wherein the control circuitry is further configured to:
monitor the welding parameters to determine frequency or severity of the spot weld; and
adjust one of duration or current level of the second or the first pulse in response.

16. The welding system of claim 9, wherein the welding process is current controlled.

17. The welding system of claim 9, wherein the further comprising a wire feeder configured to advance the welding wire to the workpiece at one or more wire feed speeds.

18. The welding system of claim 17, wherein the welding wire is commanded to advance at a speed between 100 and 500 inches per minute.

19. The welding system of claim 18, wherein the control circuitry is further configured to command the wire feeder to advance the welding wire at a constant wire feed speed during the arc phase and the background phase.

20. A welding system, comprising:
a welding power supply to provide power to a welding torch for establishing an electrical arc between the welding wire and a workpiece to perform a weld; and
control circuitry configured to control the power supply to output a waveform having a peak phase and a background phase, the waveform having a series of pulses alternating between a first pulse at a first current level during the peak phase, and a second pulse at a second current level during the background phase, wherein the control circuitry is configured to:
command the power supply to output a first pulse at a first current level above a threshold current level required to transfer a ball of molten welding wire in the peak phase;
command the power supply to output a background current at a background current level following the first pulse;
monitor one or more welding parameters;
detect a fusion event based on the one or more welding parameters; and
command the power supply to output a second pulse at a second current level greater than the background current level and below the threshold current level during the background phase in response to detection of the fusion event, wherein the second current level is sufficient to dislodge a spot weld created by the fusion event between the welding wire and the welding torch and not sufficient to transfer a ball of molten welding wire.
